(19) United States
(12) Patent Application Publication
(10) Pub. No.: US 2020/0282996 A1
(43) Pub. Date: Sep. 10, 2020

(54) DRIVING ASSISTANCE SYSTEM

(71) Applicant: TOYOTA JIDOSHA KABUSHIKI KAISHA, Toyota-shi (JP)

(72) Inventor: Shin SAKURADA, Toyota-shi (JP)

(73) Assignee: TOYOTA JIDOSHA KABUSHIKI KAISHA, Toyota-shi (JP)

(21) Appl. No.: 16/782,136

(22) Filed: Feb. 5, 2020

(30) Foreign Application Priority Data
Mar. 4, 2019 (JP) 2019-038180

(51) Int. Cl. B60W 30/18; G10L 25/51; H04R 1/40; H04R 3/00; G06K 9/00; H04N 5/232; B60R 11/02; B60R 11/04; B60W 50/06; G06N 20/00; G06N 5/04; G05B 13/02

(52) U.S. Cl. CPC B60W 30/18109; B60W 2556/45; H04R 1/406; H04R 3/005; G06K 9/00805; H04N 5/232; G06K 9/00825; B60R 11/0247; B60R 11/04; B60W 50/06; G06N 20/00; G06N 5/04; G05B 13/0265; H04R 2499/13; G10L 25/51

(57) ABSTRACT

A driving assistance system includes a plurality of vehicles in each of which a plurality of microphones and a sensor are installed and a server that includes an acquisition unit configured to acquire audio signals recorded by the microphones and sensing data measured by the sensors. The server further includes a storage unit configured to store learning data in which the audio signals and the sensing data are correlated with information indicating dangerousness of a sound source, a model generation unit configured to generate a learning model for prediction of the dangerousness of the sound source based on the audio signals and the sensing data by using the learning data, and a provision unit configured to provide the dangerousness to the vehicles.

### INCORPORATION BY REFERENCE

The disclosure of Japanese Patent Application No. 2019-038180 filed on Mar. 4, 2019 including the specification, drawings and abstract is incorporated herein by reference in its entirety.

### BACKGROUND

### 1. Technical Field

The disclosure relates to a driving assistance system.

### 2. Description of Related Art

In the related art, there is a known technique in which the direction of a sound generated by an object approaching a host vehicle and a position from which the sound comes are recognized at the same time and a driver is notified of approach information including direction information as disclosed in Japanese Unexamined Patent Application Publication No. 6-344839 (JP 6-344839 A).

### SUMMARY

However, since there are a wide range of types of sound sources, manners of approach, and vehicle-surrounding environments, the accuracy of prediction may not be high at the time of actual travel even when it is possible to predict the dangerousness of a sound source in an ideal situation.

The disclosure provides a driving assistance system with which it is possible to predict the dangerousness of a sound source at a higher accuracy in various situations.

An aspect of the disclosure relates to a driving assistance system including a plurality of vehicles and a server. In each of the vehicles, a plurality of microphones and a sensor are installed. The server includes an acquisition unit configured to acquire audio signals recorded by the microphones and sensing data measured by the sensors. The server further includes a storage unit configured to store learning data in which the audio signals and the sensing data are correlated with information indicating dangerousness of a sound source, a model generation unit configured to generate a learning model for prediction of the dangerousness of the sound source based on the audio signals and the sensing data by using the learning data, and a provision unit configured to provide the dangerousness to the vehicles.

In this case, since the learning model is generated by using an audio signal recorded when the vehicles actually travel and sensing data measured by the sensors as the learning data and the dangerousness of the sound source is predicted by the learning model, it is possible to predict the dangerousness of the sound source at a higher accuracy in various situations.

In the driving assistance system according to the aspect, the model generation unit may update the learning model by using the learning data including audio signals and sensing data newly acquired.

In this case, since the learning data is accumulated and the learning model is continuously updated, it is possible to generate the learning model by using learning data acquired in more various situations and to predict the dangerousness of the sound source at a higher accuracy.

In the driving assistance system according to the aspect, the sensors may measure position information of the vehicles and the learning model may predict the dangerousness based on the audio signals and the position information.

In this case, it is possible to predict the dangerousness of the sound source at a higher accuracy in accordance with a position at which the vehicles travel.

In the driving assistance system according to the aspect, the sensors may capture images of surrounding areas of the vehicles and the server may further include a generation unit configured to generate information indicating the dangerousness based on the images.

In this case, it is possible to perform annotation with respect to the audio signals and the sensing data and to accumulate the learning data at a high speed.

In the driving assistance system according to the aspect, the server may further include an imaging unit configured to control the sensors installed in the vehicles such that the sensors capture images of the sound source.

In this case, since the images of the sound source are captured, it is possible to clarify the type of the sound source, to enhance the learning data, and to generate the learning model with which it is possible to predict the dangerousness of the sound source at a higher accuracy.

In the driving assistance system according to the aspect, the acquisition unit may further acquire information about a surrounding environment of the vehicles and the learning model may predict the dangerousness based on the audio signals and the information about the surrounding environment.

In this case, it is possible to predict the dangerousness of the sound source at a higher accuracy in accordance with an environment under which the vehicles travel.

In the driving assistance system according to the aspect, the server may further include a slowdown controller configured to calculate a possibility that the sound source approaches any of the vehicles and to slow down a corresponding vehicle in a case where the possibility is equal to or greater than a threshold value.

In this case, it is possible to slow down a vehicle before a distance between the vehicle and a sound source becomes short and thus it is possible to achieve an improvement in safety.

In the driving assistance system according to the aspect, the slowdown controller may calculate the possibility based on the dangerousness, the audio signals, and at least one of the number of vehicles in the middle of slowdown control out of the vehicles, a record of events where the possibility has become equal to or greater than the threshold value, information about a date and time of acquisition of the audio signals, and information about a surrounding environment under which the vehicles travel.

In this case, it is possible to calculate a possibility that a sound source approaches a vehicle more accurately.

According to the aspect of the disclosure, it is possible to provide a driving assistance system with which it is possible to predict the dangerousness of a sound source at a higher accuracy in various situations.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating a network configuration of a driving assistance system according to an embodiment of the disclosure;

FIG. 2 is a diagram illustrating functional blocks of the driving assistance system according to the embodiment;

FIG. 3 is a diagram illustrating physical components of a server according to the embodiment;

FIG. 4 is a flowchart of a first process performed by the server according to the embodiment; and

FIG. 5 is a flowchart of a second process performed by the server according to the embodiment.

### DETAILED DESCRIPTION OF EMBODIMENTS

An embodiment of the disclosure will be described with reference to the attached drawings. Note that, in each drawing, elements given the same reference numerals have the same or similar configurations.

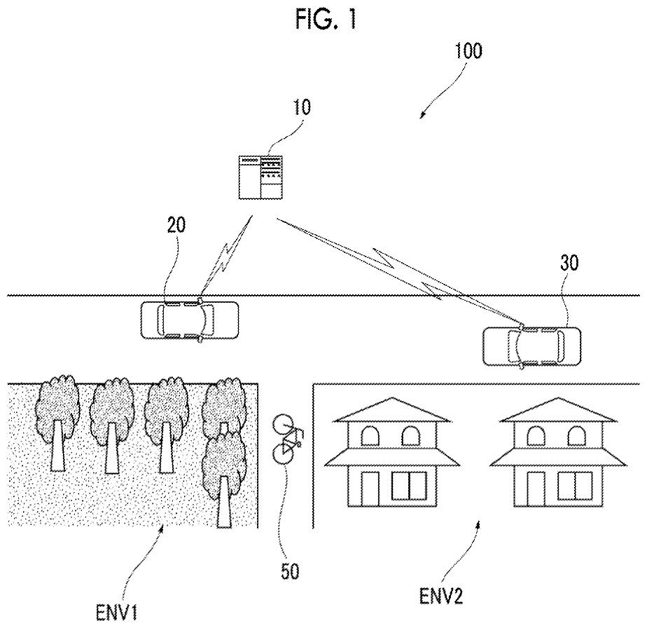

FIG. 1 is a diagram illustrating the outline of a driving assistance system 100 according to the embodiment of the disclosure. The driving assistance system 100 is provided with a server 10, a first vehicle 20, and a second vehicle 30. A plurality of microphones and a plurality of sensors are installed in each of the first vehicle 20 and the second vehicle 30. A sensor that measures the position of a host vehicle may be installed in each of the first vehicle 20 and the second vehicle 30. For example, a global positioning system (GPS) receiver may be installed in each of the first vehicle 20 and the second vehicle 30. In addition, a sensor (camera) that captures an image of a surrounding area may be installed in each of the first vehicle 20 and the second vehicle 30. The server 10 acquires audio signals recorded by means of the plurality of microphones installed in the first vehicle 20 and the second vehicle 30, position information of the first vehicle 20 and the second vehicle 30, and images acquired by imaging the vicinities of the first vehicle 20 and the second vehicle 30 and accumulates the audio signals, the position information, and the images as learning data in correlation to information indicating the dangerousness of a sound source. In an example shown in FIG. 1, a sound source 50 is a bicycle. In this case, the dangerousness of the sound source 50 may be a possibility that the sound source 50 approaches a vehicle. The server 10 generates a learning model for prediction of the dangerousness of the sound source 50 based on the audio signals and sensing data (position information or like) by using the learning data. Note that, in the present embodiment, a case where the driving assistance system 100 includes two vehicles will be described. However, the driving assistance system 100 may include any number of vehicles.

The bicycle, which is the sound source 50, is traveling on a road with a forest ENV1 on the left side and a residential area ENV2 on the right side and is approaching to a T-junction from a position which becomes a blind spot for the second vehicle 30 since the position is screened by the residential area ENV2. In such a case, it is difficult to predict the dangerousness of the sound source 50 at a high accuracy by using an audio signal recorded by the microphone installed in the second vehicle 30 solely. The server 10 according to the present embodiment predicts the dangerousness of the sound source 50 and calculates the possibility that the sound source 50 appears in front of the second vehicle 30 based on an audio signal of the sound source 50, which is recorded by the microphone installed in the first vehicle 20 through the forest ENV1, and position information of the first vehicle 20. Then, the server 10 provides the predicted dangerousness of the sound source 50 to the first vehicle 20 and the second vehicle 30. Accordingly, the driver of the second vehicle 30 can be aware of approach of the sound source 50 from the blind spot and can drive safely.

As described above, in the case of the driving assistance system 100 according to the present embodiment, since a learning model is generated by using an audio signal recorded when the vehicles 20, 30 actually travel and sensing data measured by a sensor as learning data and the dangerousness of the sound source 50 is predicted by the learning model, it is possible to predict the dangerousness of the sound source 50 at a higher accuracy in various situations.

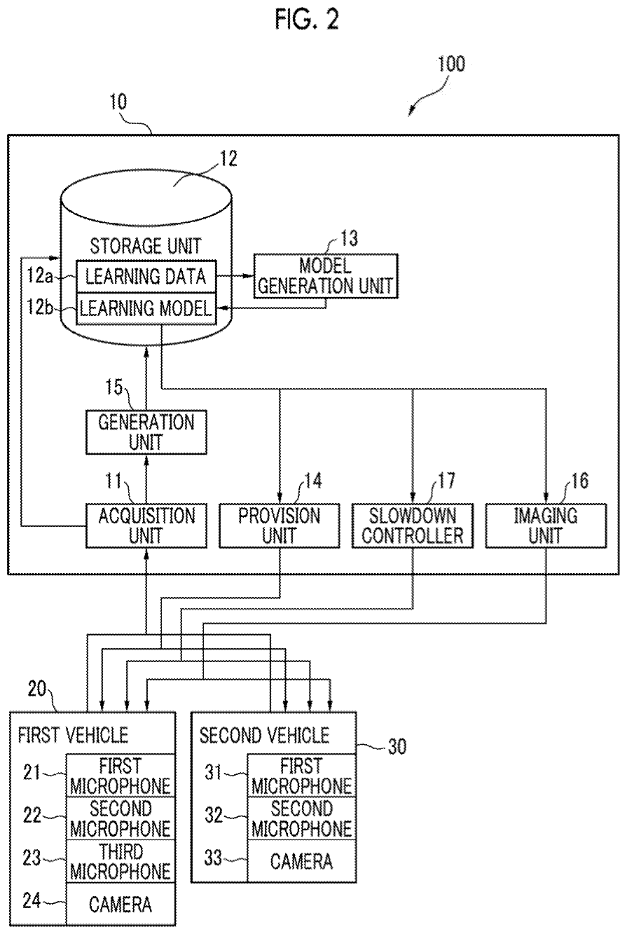

FIG. 2 is a diagram illustrating functional blocks of the driving assistance system 100 according to the present embodiment. The driving assistance system 100 is provided with the server 10, the first vehicle 20, and the second vehicle 30. The server 10 includes an acquisition unit 11, a storage unit 12, a model generation unit 13, a provision unit 14, a generation unit 15, an imaging unit 16, and a slowdown controller 17. The first vehicle 20 includes a first microphone 21, a second microphone 22, a third microphone 23, and a camera 24. The second vehicle 30 includes a first microphone 31, a second microphone 32, and a camera 33.

The acquisition unit 11 acquires audio signals recorded by the microphones (first microphone 21, second microphone 22, third microphone 23, first microphone 31, and second microphone 32) and sensing data measured by the sensors (GPS receiver (not shown), camera 24, and camera 33). The acquisition unit 11 may acquire the audio signals and the sensing data from the first vehicle 20 and the second vehicle 30 via a wireless communication network. The acquisition unit 11 may further acquire information about the surrounding environment of the vehicles 20, 30. For example, the information about the surrounding environment may be extracted from map information based on position information of the vehicles 20, 30 and may be information about the forest ENV1 and the residential area ENV2 in the case of the example shown in FIG. 1. The acquisition unit 11 may store the audio signals and the sensing data in the storage unit 12 in correlation with a time at which the audio signals and the sensing data are acquired.

The storage unit 12 stores learning data 12a in which the audio signals and the sensing data are correlated with information indicating the dangerousness of a sound source. The learning data may be a dataset in which an audio signal and position information are correlated with information indicating the dangerousness of a sound source, a dataset in which an audio signal and information about a surrounding environment are correlated with information indicating the dangerousness of a sound source, or a dataset in which an audio signal, position information, and information about a surrounding environment are correlated with information indicating the dangerousness of a sound source. The storage unit 12 stores the learning model 12b generated by the model generation unit 13.

The model generation unit 13 generates a learning model 12b for prediction of the dangerousness of the sound source 50 based on the audio signals and the sensing data by using the learning data. The model generation unit 13 may update the learning model 12b by using the learning data 12a including audio signals and sensing data newly acquired. When the learning data 12a is accumulated and the learning model 12b is continuously updated in this manner, it is possible to generate the learning model 12b by using the learning data 12a acquired in more various situations and to predict the dangerousness of the sound source 50 at a higher accuracy.

In a case where position information of the vehicles 20, 30 is measured by means of the sensors installed in the vehicles 20, 30, the model generation unit 13 may generate the learning model 12b for prediction of the dangerousness of the sound source 50 based on the audio signals and the position information. In this case, it is possible to predict the dangerousness of the sound source 50 at a higher accuracy in accordance with a position at which the vehicles 20, 30 travel.

In addition, the model generation unit 13 may generate the learning model 12b for prediction of the dangerousness of the sound source 50 based on the audio signals and the information about the surrounding environment. In this case, it is possible to predict the dangerousness of the sound source 50 at a higher accuracy in accordance with an environment under which the vehicles 20, 30 travel.

The provision unit 14 provides, to the vehicles 20, 30, the dangerousness predicted by the learning model 12b. The provision unit 14 may provide the predicted dangerousness of the sound source 50 to the first vehicle 20 and the second vehicle 30 via a wireless communication network. Accordingly, the drivers of the vehicles 20, 30 can grasp the dangerousness of the sound source 50 in a blind spot and can drive safely.

The generation unit 15 generates information indicating the dangerousness of the sound source 50 based on images captured by the cameras 24, 33. The generation unit 15 may recognize the name of the sound source 50 shown in the images by using a known image recognition technique and calculate a value indicating the degree of approach of the sound source 50 with respect to the vehicles 20, 30 to generate the information indicating the dangerousness of the sound source 50. With the generation unit 15, it is possible to perform annotation with respect to the audio signals and the sensing data and to accumulate the learning data 12a at a high speed.

The imaging unit 16 controls the sensors (cameras 24, 33) installed in the vehicles 20, 30 to capture an image of the sound source 50. In a case where audio signals of the sound source 50 are recorded by the vehicles 20, 30, the imaging unit 16 may control the cameras 24, 33 installed in the vehicles 20, 30 to capture an image of the sound source 50. Since the image of the sound source 50 is captured, it is possible to clarify the type of the sound source 50, to enhance the learning data 12a, and to generate the learning model 12b with which it is possible to predict the dangerousness of the sound source 50 at a higher accuracy.

The slowdown controller 17 calculates a possibility that the sound source 50 approaches any of the vehicles 20, 30 and in a case where the possibility is equal to or greater than a threshold value, the slowdown controller 17 slows down a corresponding vehicle. Here, in a case where a possibility that any sound source 50 approaches any of the vehicles 20, 30 is equal to or greater than the threshold value, the storage unit 12 may store an audio signal, position information, information about a surrounding environment, an image of the sound source 50, and information about a date and time that relate to the above-described event. For example, the slowdown controller 17 may calculate a possibility that the sound source 50 approaches the second vehicle 30 and in a case where the possibility is equal to or greater than the threshold value, the slowdown controller 17 may forcibly slow down the second vehicle 30. Accordingly, it is possible to slow down a vehicle before a distance between the vehicle and a sound source becomes short and thus it is possible to achieve an improvement in safety.

The slowdown controller 17 may calculate the possibility that the sound source 50 approaches a vehicle based on the dangerousness predicted by the learning model 12b, the audio signals, and at least one of the number of vehicles in the middle of slowdown control out of the vehicles 20, 30, a record of events where a possibility that the sound source 50 approaches a vehicle has become equal to or greater than the threshold value, information about a date and time of acquisition of the audio signals, and information about a surrounding environment under which the vehicles 20, 30 travel. In this case, it is possible to calculate a possibility that a sound source approaches a vehicle more accurately.

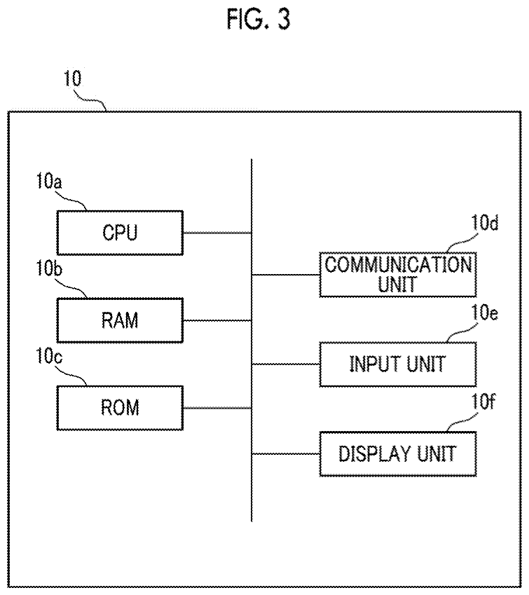

FIG. 3 is a diagram illustrating physical components of the server 10 according to the present embodiment. The server 10 includes a central processing unit (CPU) 10a corresponding to a calculation unit, a random access memory (RAM) 10b corresponding to a storage unit, a read only memory (ROM) 10c corresponding to a storage unit, a communication unit 10d, an input unit 10e, and a display unit 10f. The components described above are connected to each other via a bus such that data can be transmitted and received to and from each other. Note that, although a case where the server 10 includes one computer will be described in this example, the server 10 may be realized by a plurality of computers combined with each other. In addition, the components shown in FIG. 3 are merely examples. The server 10 may include a component other than the components shown in FIG. 3 and may not include part of the components shown in FIG. 3.

The CPU 10a is a controller that performs control relating to execution of a program stored in the RAM 10b or the ROM 10c or data calculation and processing. The CPU 10a is a calculation unit that executes a program (driving assistance program) for prediction of the dangerousness of a sound source based on audio signals and sensing data acquired from the vehicles. The CPU 10a receives various kinds of data from the input unit 10e or the communication unit 10d, causes the display unit 10f to display the result of data calculation, or stores the various kinds of data in the RAM 10b or the ROM 10c.

The RAM 10b is a storage unit in which data can be rewritten and may be a semiconductor storage element, for example. The RAM 10b may store a program to be executed by the CPU 10a, an audio signal, and data such as position information and vehicle speed information. Note that, those described above are merely an example and the RAM 10b may store data other than those described above and a part of those described above may not be stored in the RAM 10b.

The ROM 10c is a storage unit from which data can be read and may be a semiconductor storage element, for example. The ROM 10c may store a driving assistance program or data not to be rewritten, for example.

The communication unit 10d is an interface that connects the server 10 to another device. The communication unit 10d may be connected to a communication network N such as the Internet.

The input unit 10e receives input of data from a user and may include a keyboard and a touch panel, for example.

The display unit 10f visually displays the result of calculation performed by the CPU 10a and may be, for example, a liquid crystal display (LCD). The display unit 10f may display information indicating the dangerousness of a sound source that is generated by the generation unit 15, for example.

The driving assistance program may be provided by being stored in a computer-readable storage medium such as the RAM 10b or the ROM 10c and may be provided via the communication network connected via the communication unit 10d. In the server 10, the operations of the acquisition unit 11, the model generation unit 13, the provision unit 14, the generation unit 15, the imaging unit 16, and the slowdown controller 17 described with reference to FIG. 2 are realized when the CPU 10a executes the driving assistance program. Note that, the physical components described thereof are merely examples and the components may not be independent of each other. For example, the server 10 may be provided with a large-scale integration (LSI) circuit acquired by integrating the CPU 10a, the RAM 10b, and the ROM 10c.

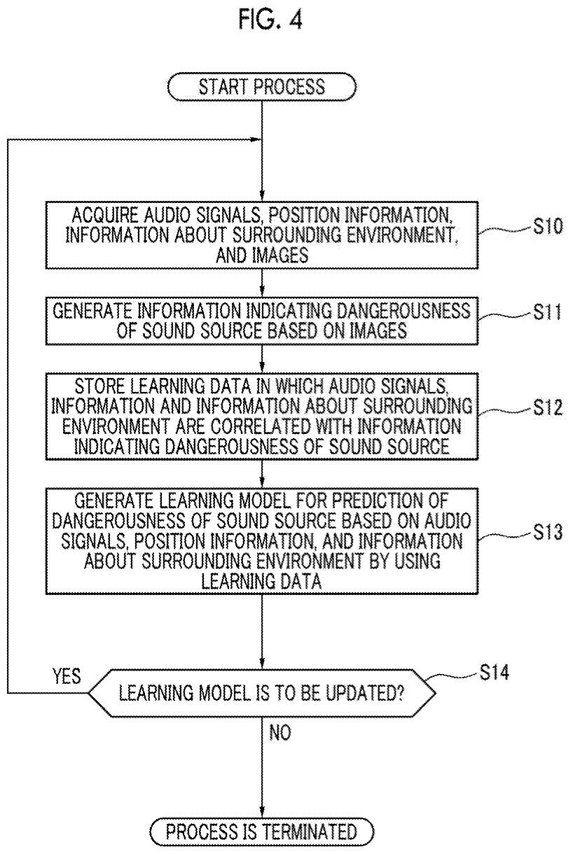

FIG. 4 is an example of a flowchart of a first process performed by the server 10 according to the present embodiment. The first process is a process of newly creating a learning model or a process of updating a learning model.

First, the server 10 acquires audio signals, position information, information about a surrounding environment, and images (S10). Then, the server 10 generates information indicating the dangerousness of a sound source based on the images (S11). Thereafter, the server 10 stores learning data in which the audio signals, the position information, and the information about the surrounding environment are correlated with the information indicating the dangerousness of the sound source (S12).

In a case where a predetermined amount of learning data or more is accumulated, the server 10 generates a learning model for prediction of the dangerousness of the sound source based on the audio signals, the position information, and the information about the surrounding environment by using the learning data (S13).

Thereafter, in a case where the learning model is to be updated continuously (S14: YES), the server 10 repeats the processes in S10 to S13. Meanwhile, in a case where the learning model is not to be updated (S14: NO), the first process is terminated.

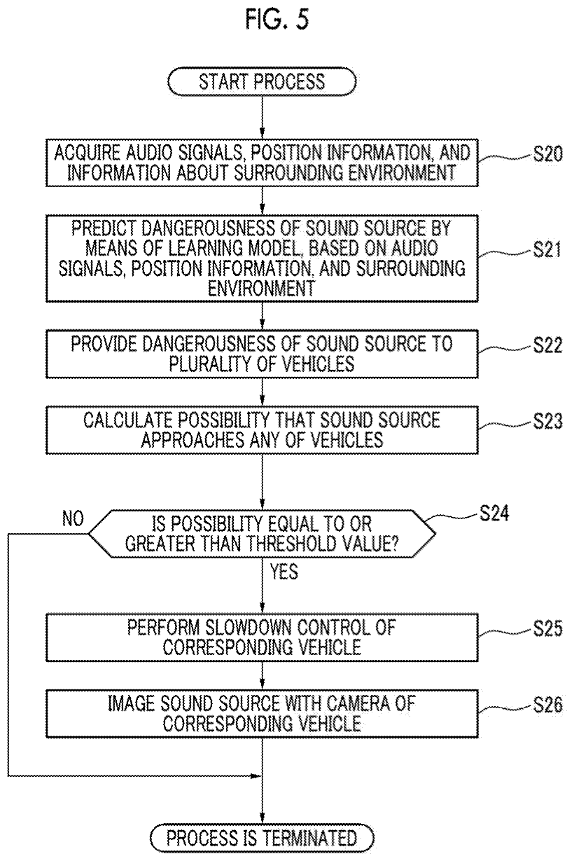

FIG. 5 is an example of a flowchart of a second process performed by the server 10 according to the present embodiment. The second process is a process of predicting the dangerousness of a sound source by means of the generated learning model.

First, the server 10 acquires audio signals, position information, and information about a surrounding environment (S20). Then, the server 10 predicts the dangerousness of a sound source by means of the learning model, based on the audio signals, the position information, and the surrounding environment (S21). The server 10 provides the predicted dangerousness of the sound source to a plurality of vehicles (S22).

In addition, the server 10 calculates a possibility that the sound source approaches any of the vehicles (S23). In a case where the possibility is equal to or greater than a threshold value (S24: YES), the server 10 performs control such that a corresponding vehicle is slowed down (S25). In addition, the server 10 performs control to image the sound source with a camera installed in the vehicle (S26). The server 10 may generate information indicating the dangerousness of the sound source based on the captured image of the sound source and store the information as new learning data in correlation with the audio signals, the position information, and the surrounding environment. Then, the second process of the server 10 is terminated. Note that, the server 10 may repeat the second process.

The embodiment described above is intended to facilitate understanding of the disclosure and is not to be interpreted as limiting the disclosure. The elements and arrangement, materials, condition, shape, and size thereof included in the embodiment are not limited to those exemplified and can be modified appropriately. In addition, components described in different embodiments can be partially substituted or combined with each other.

What is claimed is:

1. A driving assistance system comprising:
a plurality of vehicles in each of which a plurality of microphones and a sensor are installed; and
a server that includes an acquisition unit configured to acquire audio signals recorded by the microphones and sensing data measured by the sensors,
wherein the server further includes a storage unit configured to store learning data in which the audio signals and the sensing data are correlated with information indicating dangerousness of a sound source, a model generation unit configured to generate a learning model for prediction of the dangerousness of the sound source based on the audio signals and the sensing data by using the learning data, and a provision unit configured to provide the dangerousness to the vehicles.

2. The driving assistance system according to claim 1, wherein the model generation unit updates the learning model by using the learning data including audio signals and sensing data newly acquired.

3. The driving assistance system according to claim 1, wherein:
the sensors measure position information of the vehicles; and
the learning model predicts the dangerousness based on the audio signals and the position information.

4. The driving assistance system according to claim 1, wherein:
the sensors capture images of surrounding areas of the vehicles; and
the server further includes a generation unit configured to generate information indicating the dangerousness based on the images.

5. The driving assistance system according to claim 4, wherein the server further includes an imaging unit configured to control the sensors installed in the vehicles such that the sensors capture images of the sound source.

6. The driving assistance system according to claim 1, wherein:
the acquisition unit further acquires information about a surrounding environment of the vehicles; and
the learning model predicts the dangerousness based on the audio signals and the information about the surrounding environment.

7. The driving assistance system according to claim 1, wherein the server further includes a slowdown controller configured to calculate a possibility that the sound source approaches any of the vehicles and to slow down a corresponding vehicle in a case where the possibility is equal to or greater than a threshold value.

8. The driving assistance system according to claim 7, wherein the slowdown controller calculates the possibility based on the dangerousness, the audio signals, and at least one of the number of vehicles in the middle of slowdown control out of the vehicles, a record of events where the possibility has become equal to or greater than the threshold value, information about a date and time of acquisition of the audio signals, and information about a surrounding environment under which the vehicles travel.
